(19) United States
(12) Patent Application Publication
(10) Pub. No.: US 2025/0044435 A1
(43) Pub. Date: Feb. 6, 2025

(54) OFDM-BASED JOINT RADAR AND COMMUNICATION

(71) Applicant: ISTANBUL MEDIPOL UNIVERSITESI, Istanbul (TR)

(72) Inventors: Salah Eddine ZEGRAR, Istanbul (TR); Hüseyin ARSLAN, Istanbul (TR)

(21) Appl. No.: 18/718,264

(22) PCT Filed: Dec. 7, 2022
(86) PCT No.: PCT/TR2022/051431

§ 371 Date: Jun. 10, 2024

(30) Foreign Application Priority Data
Dec. 9, 2021 (TR) 2021/019525

(51) Int. Cl. G01S 13/26; G01S 13/522

(52) U.S. Cl. CPC G01S 13/26; G01S 13/522

(57) ABSTRACT

A method for designing pilots inserted into orthogonal frequency division multiplexing (OFDM) waveform intended for channel estimation such that the channel can be seen and estimated in both time-frequency and delay-Doppler domains. The ability of estimating the sparsest channel impulse response will provide environment mapping and therefore sensing.

### TECHNICAL FIELD

Present invention relates to a new method for designing pilots inserted into orthogonal frequency division multiplexing (OFDM) waveform intended for channel estimation such that the channel can be seen and estimated in both time-frequency and delay-Doppler domains.

The ability of estimating the sparsest channel impulse response will provide environment mapping and therefore sensing.

### PRIOR ART

Joint Communication and Sensing (JCAS) is proposed to use one hardware platform and one waveform to perform two radio frequency (RF) functions, i.e., communications and sensing, thus saving the cost and power as compared to systems having two separate transmitters. JCAS has been highly recommended for many different applications such as internet of things (IoT), health care, etc. In order to support the high-mobility use cases in mobile communications in a better way, OFDM is proposed for a simultaneous performance of communication and radar.

However, to extract the radar information processing OFDM at the receiver side is computationally expensive. In addition, the high complexity at the receiver side implies longer delay in obtaining the range and velocity information in real-time.

A noise-Orthogonal Frequency Division Multiplexing (noise-OFDM) waveform simultaneously transmitting data between several distributed radars by allocating different sub-carriers to radar and communication is proposed in a publication by Surender, S. C., et al, published in 2011. The work investigates the impact of communication data on target range but does not consider the impact on Doppler shift. The work by Sturm, C., et al, published in 2011 shows that OFDM offers high dynamic range, independence from the transmitted user data, and efficient implementation based on FFT. A spectrally interleaved multi-carrier signal for radar network is investigated in a publication by Sturm, C., et al, published in 2013 to reduce the interference between the users in a multiuser scenario compared to the case where the interferer occupies the same bandwidth like the classical OFDM. The downside of the work is that the maximum unambiguous measurement range is reduced proportionally to the number of users. In a work by Chabriel, G., published in 2017, an adaptive filter for parameter detection of targets based on OFDM passive radar is developed as the output of an optimization problem. The shortcoming is the complexity of the receiver for solving such an optimization problem.

### AIM OF THE INVENTION

The present invention aims to present a method for sparse channel representation in delay-Doppler domain.

The present invention also aims to present a method for estimating the wireless channel taps along with their corresponding delay and Doppler shifts.

The inventors also aim to provide a method having backwards compatibility and with simple low-complexity doubly dispersible channel (time and frequency selective channel) equalizer.

### BRIEF DESCRIPTION OF THE INVENTION

The invention is directed to a method for designing pilots inserted within orthogonal frequency division multiplexing (OFDM) waveform intended for channel estimation wherein said method comprises the general steps of; (i) Waveform generation at the transmitter and (b) estimation and detection at the receiver.

The method is carried out in such a way that channel can be seen and estimated in both time- frequency and delay-Doppler domains.

The disclosed invention makes OFDM waveform robust in doubly dispersive channels (time and frequency selective channels) without changing too much on the general structure of the conventional OFDM, thus it is suitable for all mobility cases in wireless communication. Therefore, the operators will need changing the infrastructure of the already existing technology. By doing so the environment is sensed with fine resolution

The disclosed invention can solve the following problems related to OFDM:
1. Sparse channel representation in delay-Doppler domain.
2. Short range and small velocity estimation.
3. Slow tracking.
4. High computation complexity.
5. Complex receiver structure.
6. Backward compatibility.

As such, the method of the invention provides (i) estimation of the wireless channel in both time-frequency and delay-Doppler domains, (ii) backward compatibility with OFDM, where only the pilot values are altered, (iii) long range and large velocity estimation and (iv) less complex processing compared to prior art methods.

### EXPLANATION OF FIGURES

FIG. 1: The OFDM pilot distribution used in time-frequency

FIG. 2: The equivalent representation of the pilots in FIG. 1 in the delay-Doppler domain using the disclosed design

### DETAILED DESCRIPTION OF THE INVENTION

As mentioned above an embodiment of the invention is a method for designing pilots inserted within orthogonal frequency division multiplexing (OFDM) waveform intended for channel estimation wherein said method comprises the general steps of; (i) Waveform generation at the transmitter and (ii) estimation and detection at the receiver.

In an embodiment of the invention the step of generation at the transmitter comprises;
Defining the pilot ratio at the beginning,
Choosing the pilots in time-frequency that are equally spaced in frequency and shifted at each time slot,
Choosing the pilots' complex values to provide localization of the representation in the delay-Doppler domain.

Defining the pilot ratio affects the range of delays and Dopplers estimated.

In an embodiment of the invention choosing the pilots in time-frequency is carried out by assigning them specific complex values. Such that, upon assigning the specific complex values, the equivalent representation of these pilots in delay-Doppler domain is localized in delay-Doppler domain.

The pilot values are assigned in the time-frequency domain so that they show up sparse and localized in delay-Doppler domain. One way of doing that is by backward design where we assign few pilots in delay-Doppler domain and consider their transform to time-frequency as the OFDM pilots.

Further, the communication data will be assigned to the empty grid in the time-frequency domain.

In an embodiment of the invention, the invention relates to a method for designing pilots inserted within orthogonal frequency division multiplexing (OFDM) waveform intended for channel estimation wherein said method comprises the steps of;
(i) Waveform generation at the transmitter comprising the steps of (or which carries out the steps of);
   Defining the pilot ratio at the beginning,
   Choosing the pilots in time-frequency that are equally spaced in frequency and shifting at each time slot,
   Choosing the pilots' complex values to provide localization of the representation in the delay-Doppler domain.
and
(ii) estimation and detection at the receiver.

In an embodiment of the invention the step of estimation and detection at the receiver comprises transforming the received pilots' values to delay-Doppler domain where every reflection from the environment is seen as tap with a specific power, delay shift, and Doppler shift.

In other words; in general the objects in the environment reflects the transmitted electromagnetic wave. At the receiver side we receive the reflection one by one (with delay) based on the location of the object. The delay between the reflections can be used to calculate the range between the object and the receiver. Furthermore, if the object is moving relatively with the receiver, then a doppler will be introduced and added to the electromagnetic wave. The doppler shift can be used to calculate the relative speed between the object (reflector) and the receiver.

In an embodiment of the invention the invention is directed to a method for designing pilots inserted into orthogonal frequency division multiplexing (OFDM) waveform intended for channel estimation wherein said method comprises the steps of;
(i) waveform generation at the transmitter comprising the steps of (or which carries out the steps of);
   Defining the pilot ratio at the beginning,
   Choosing the pilots in time-frequency that are equally spaced in frequency and shifting at each time slot,
   Choosing the pilots' complex values to provide localization of the representation in the delay-Doppler domain.
and
(ii) estimation and detection at the receiver comprising transforming the received pilots' values to delay-Doppler domain where every reflection from the environment is seen as tap with a specific power, delay shift, and Doppler shift

### EXAMPLES

### Example 1: Application of the Method According to Present Invention

### At the Transmitter Side:

The pilots are carefully chosen in time-frequency domain by assigning them specific complex values so that the equivalent representation of these pilots in delay-Doppler domain is localized in delay-Doppler domain. The following design criteria must be taken into consideration:
First, the pilot ratio is defined at the beginning, this step will affect the range of delays and Dopplers estimated.
The pilots in time-frequency are chosen to be equally spaced in frequency and shifted at each time slot.
The pilots' complex values are chosen to localize the representation in the delay-Doppler domain.

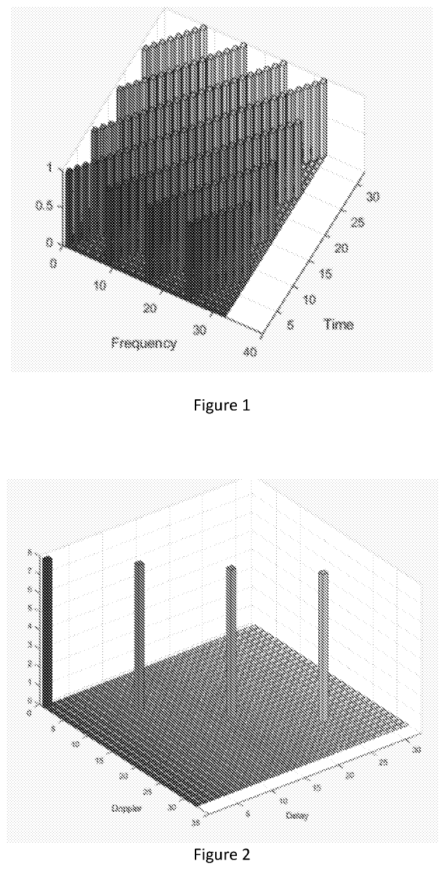

For example as seen in FIG. 1, if the pilots are carefully chosen in time-frequency domain by assigning them specific complex values. The equivalent representation of these pilots in delay-Doppler domain is shown in FIG. 2 where all the pilots in time-frequency become localized in delay-Doppler domain.

The communication data will be assigned to the empty grid in the time-frequency domain.

### At the Receiver Side:

At the receiver side the designed system can used for sensing as follows: The receiver transforms the received pilots' values to delay-Doppler domain where every reflection from the environment is seen as tap with a specific power, delay shift, and Doppler shift.

### INDUSTRIAL APPLICABILITY OF THE INVENTION

The method of the invention is applicable to industry which is interested in sensing, or joint communication and sensing.

Owing to the increase in spectrum congestion, researchers are interested in devising new ways of using the spectrum more efficiently. In addition to the spectrum congestion problem, efforts in this direction have been further accelerated by the fact that, in recent years, radar has found a number of new applications in the consumer market, in addition to its conventional applications in military, aviation and meteorology. This includes applications in the automotive industry, such as adaptive cruise control, lane change assistance, cross-traffic alerts and obstacle avoidance in autonomous vehicles. Radars are also finding new applications in health, such as in assisted living. At the same time, there is increased interest in vehicle-to-vehicle (V2V) communications and considerable efforts have been made to enable various safety functions, smart traffic application and to develop autonomous vehicles. Therefore, there are a number of applications that stand to benefit from the integration of radar and communication functions. Hence, spectrum sharing between radar and communication systems has attracted significant interest in recent years.

More specifically any wireless communication technology can utilize this invention to provide reliable joint communication and radar using OFDM waveform or only sensing with low-complexity receivers. Standards like 3GPP-based cellular and IEEE 802.11 based Wi-Fi networks, or any wireless network are particularly relevant to the invention due to the support of multipoint coordination provided in both standards. Furthermore, the described method in this invention can be implemented on any device, system or network capable of supporting any of the aforementioned standards, for instance: code division multiple access (CMDA), frequency division multiple access (FDMA), Global System for Mobile communications (GSM), GSM/General Packet Radio Service (GPRS), Enhanced Data GSM Environment (EDGE), Wideband-CDMA (W-CDMA), Evolution Data Optimized (EV-DO), High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (NR), or other known signals that are used to communicate within a wireless, cellular or internet of things (IoT) network.

Around these basic concepts, it is possible to develop several embodiments regarding the subject matter of the invention; therefore, the invention cannot be limited to the examples disclosed herein, and the invention is essentially as defined in the claims. Separate embodiments of the invention can be combined where appropriate.

It is obvious that a person skilled in the art can convey the novelty of the invention using similar embodiments and/or that such embodiments can be applied to other fields similar to those used in the related art. Therefore it is also obvious that these kinds of embodiments are void of the novelty criteria and the criteria of exceeding the known state of the art.

1. A method for designing pilots inserted within orthogonal frequency division multiplexing (OFDM) waveform intended for channel estimation, the method comprising the steps of:
waveform generation at the transmitter is carried out by;
defining the pilot ratio at the beginning
choosing the pilots in time-frequency that are equally spaced in frequency and shifting at each time slot;
choosing the pilots' complex values to provide localization of the representation in the delay-Doppler domain; and
estimation and detection at the receiver.

2. The method of claim 1, wherein the estimation and detection at the receiver comprises transforming the received pilots' values to delay-Doppler domain where every reflection from the environment is seen as tap with a specific power, delay shift, and Doppler shift.
